(19) United States
(12) Patent Application Publication
(10) Pub. No.: US 2015/0286371 A1
(43) Pub. Date: Oct. 8, 2015

(54) CUSTOM EMOTICON GENERATION

(71) Applicant: ANIWAYS ADVERTISING SOLUTIONS LTD., RaAnana (IL)

(72) Inventor: Yoav Degani, Tel-Aviv (IL)

(21) Appl. No.: 14/439,670

(22) PCT Filed: Oct. 31, 2013
(86) PCT No.: PCT/IL2013/050898

§ 371 Date: Apr. 30, 2015

Related U.S. Application Data
(60) Provisional application No. 61/720,524, filed on Oct. 31, 2012.

(51) Int. Cl. G06F 3/0484; G06F 3/0481; G06Q 30/02; G06F 17/27; H04L 12/58

(52) U.S. Cl. CPC G06F 3/04842; G06F 17/274; H04L 51/04; G06Q 30/0276; G06F 3/04817; G06Q 30/0267

(57) ABSTRACT

Systems and methods of dynamically generating a customized emoticon palette are disclosed. An emoticon generation system identifies, according to content analysis, features and associated intended indications extracted from a textual message on a mobile device which are embedded into an emoticon. The sender may select and insert one or more emoticons into a text message. The emoticon is then transmitted from the sender to the recipient along with the associated intended indication such that the recipient can interpret the intended indication when the emoticon is displayed.

### BACKGROUND AND FIELD OF THE INVENTION

The present invention, in some embodiments thereof, relates to emoticon palettes and, more specifically, but not exclusively, to a method and system for dynamically generated emoticons.

Advertisers and merchants, in an endeavor to advocate their promotional content, are dedicating more and more resources to the development and execution of their marketing campaigns in the increasingly wide variety of online and electronic media formats. Consequently, instant messaging, short messaging service (SMS), email, chartroom and other forms of textual communication protocols became highly instrumental in the proliferation of promotional content; user targeted and dynamically created advertisements.

Due to advances in hardware and the emergence of efficient messaging technologies, conversation and communication of textual and, to a lesser degree, vocal and graphical messages between parties has gained wide spread popularity amongst messaging client users (also referred to herein as consumers or subscribes and may be used interchangeably).

The communication of textual data most notably takes place between a plurality of messaging clients via a mobile device and, to a lesser degree, via personal computers.

A typical aspect of such a messaging client application is the ability of a user, the broadcaster, interacting with an apparatus via a message editor, to select and embed an emoticon from a palette consisting fixed or a pre-existing number of emoticons into the message editor of the messaging client and transmit the message to a plurality of users, the recipients.

As used herein, the term “emoticon”, derived from the combination of the words “emotion” and “icon”, refers to a minute graphical symbol used as a substitute for verbal or visual communication cues meant to assist conveying the mod or emotion of a textual message, instant messaging, short messaging service (SMS), email, chartroom and other forms of textual communication protocols. Despite the fact that emoticons are predominantly utilized to express emotions, this is not always the case and there are emoticons in existence that represent, for instance an idea, a thought or a philosophical concept.

As used herein, the term “emoticon palette” means a segment of a user interface module in messaging and instant messaging client applications that presents a user interface and used to display and present selectable emoticons to the user. Characteristically, these emoticons have pre-defined set of attributes such as shape, size and color and are retrieved from a local or remote emoticon object store.

During the last decade, the diversity of existing emoticons has increased substantially, from just a few basic combinations of a “smiley face” to an overabundance of complex and rich graphical and sometimes even animated emoticons. The plethora of existing emoticons available, possibly thousands or more, enforces several restrictions on messaging client applications such that it is possible only to employee a fraction of the available emoticon combinations on a messaging client emoticon palette.

Furthermore, it is not viable to exhaustively display each and every emoticon combination on a palette limited by size, length and height and even through the utilization of client side paging, a method in which a graphical scroll bar is employed on a user interface to page through a range of possible emoticons, it would still be cumbersome to page on an inherently small screen of a mobile device and limited total user interface area typical of a of messaging client. Moreover, it is practically impossible to create a pre-determined list of emoticons corresponding to each and every human emotion.

Moreover, methods and devices for uniquely generating and encoding an emoticon via a one-to-one emoticon to plain character sequence transformation are well known and well researched in the industry. These sequences can then be included in a textual message, transmitted to a plurality of receiving parties in a message and then lastly, used in the reconstruction of the actual emoticon back to its original graphical form which is displayable on the messaging client.

Many commercial vendors such as advertisers and merchants dedicate considerable resources to developing and executing marketing campaigns to increase the market share of the products and services they provide. Such campaigns possibly will engage the use of an extensive range of electronic media formats.

### SUMMARY

According to some embodiments of the present invention there is provided a method of dynamically generating an emoticon palette, including providing content presented to a user in a textual message editor of a terminal, providing an access to a dataset including a plurality of emoticons each associated at least one of a plurality of intention indications, identifying, according to a content analysis, at least one intention indication in the content, selecting a group of emoticons from the plurality of emoticons according to a match between the at least one intention indication and the plurality of intention indications, adding the selected group to an emoticon palette of the textual message editor, entering by the user which uses the textual message editor, at least one member of the selected group into a textual message in response to a selection from the emoticon palette, and transmitting the textual message.

Optionally, wherein the plurality of emoticons includes a promotional content.

Optionally, wherein the content is received from the user as an input into the textual message.

Optionally, wherein the content is extracted from another textual message presented to the user using the user interface, the textual message is a response to another textual message.

Optionally, wherein the content is an instant messaging content and the textual message is an instant messaging message.

Optionally, wherein the content is a short message service (SMS) content and the textual message is an SMS message.

Optionally, wherein the content includes a textual content and the content analysis is textual analysis.

Optionally, wherein the content includes an incomplete sentence having at least one morpheme, the content analysis is a textual analysis.

Optionally, wherein the content includes at least one image and the content analysis is an image analysis.

Optionally, wherein the providing an access to a dataset includes establishing a communication with a remote network node which manages the dataset.

Optionally, wherein the identifying includes identifying a current location of the terminal, the selecting is performed according to current location.

Optionally, further including identifying a plurality of applications installed in the terminal, and wherein the selecting is performed according to the plurality of applications.

Optionally, further including identifying at least one keyword in a search query submitted to a search engine using in the terminal, and wherein the selecting is performed according to the at least one keyword.

According to some embodiments of the present invention there is provided a communication terminal, including a display, a user interface module which presents a user interface on the display for entering by a user textual content for a textual message, an emoticons database access module which provides an access to a dataset including a plurality of emoticons each associated at least one of a plurality of intention indications, a selection module which identifies, according to a textual analysis, at least one intention indication of the user in the textual content and selects a group of emoticons from the plurality of emoticons according to a match between the at least one intention indication and the plurality of intention indications, an emoticon palette generation module which adds the selected group to an emoticon palette of the user interface, wherein the user interface allows the user to enter at least one member of the selected group into the textual message, and wherein the communication terminal transmits the textual message with the at least one member and the textual content.

According to some embodiments of the present invention there is provided a method of dynamically selecting a set of emoticons, including providing content presented to a user in a textual message editor of a terminal, providing an access to a dataset including a plurality of emoticons each associated at least one of a plurality of location indications, identifying to a current location of the terminal, selecting a group of emoticons from the plurality of emoticons according to a match between the current location and the plurality of location indications, adding the selected group to an emoticon palette of the textual message editor, entering by the user which uses the textual message editor, at least one member of the selected group into a textual message in response to a selection from the emoticon palette, and transmitting the textual message.

According to some embodiments of the present invention there is provided a method of dynamically highlighting morphemes, including providing content presented to a user in a textual message editor of a terminal, providing an access to a dataset including a plurality of emoticons each associated with at least one of a plurality of intention indications, identifying at least one morpheme in the content, identifying a match between the at least one morpheme and the plurality of intention indications, highlighting the at least one morpheme in response to the match, presenting at least one emoticon from the plurality of emoticons to the user in the textual message editor, the at least one emoticon being selected according to the match, substituting the at least one morpheme in the content with the at least one emoticon in response to a user selection indicating the selection of the at least one emoticon, and transmitting the textual message with the at least one emoticon.

According to some embodiments of the present invention there is provided a method of dynamically associating promotional content, including receiving a textual message created by a user in a textual message editor of a terminal to an operator, the textual message is designated to at least one recipient, detecting at least one emoticon in the textual message, adding at least one promotional content to the at least one emoticon in the textual message, and forwarding an adjusted textual message that includes the textual message and the at least one emoticon with the at least one promotional content to the at least one recipient.

Optionally, wherein the textual message is an instant messaging message.

Optionally, further including presenting the textual message and the at least one emoticon with the at least one promotional content to the at least one recipient and to the user in a chat user interface.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a high level block diagram and architecture of a system used for the dynamic generation of emoticons, according to some embodiments of the present invention;

FIG. 2 is a schematic illustration of an exemplary mobile device, having a user interface and a messaging client application for practicing the present invention and assisting a consumer in selecting an emoticon from a dynamically generated emoticon palette, according to some embodiments of the present invention;

FIG. 3 is an exemplary view of a mobile device user interface displaying text entered by the user, according to some embodiments of the present invention;

FIG. 4 is a of an exemplary module used for the generation of custom emoticons, according to some embodiments of the present invention;

FIG. 5 is a flowchart illustrating an exemplary emoticon generation scenario in which, following a message analysis, a match is made between the analysis and a list of merchants and products, according to some embodiments of the present invention;

FIG. 6 is a flowchart illustrating an exemplary emoticon generation scenario in which, following an image analysis, a match is made between the analysis and a list of merchants and products, according to some embodiments of the present invention;

FIG. 7 is a sequence diagram illustrating an exemplary revenue generating model, according to some embodiments of the present invention;

FIG. 8 is an exemplary schematic illustration of a mobile device and exemplary text that is highlighted, according to some embodiments of the present invention; and

FIG. 9 is an exemplary schematic illustration of a mobile device and exemplary dynamically generated emoticons, according to some embodiments of the present invention.

### DETAILED DESCRIPTION

The present invention, in some embodiments thereof, relates to emoticon palettes and, more specifically, but not exclusively, to a method and system for dynamically generated emoticons.

According to some embodiments of the present invention, an emoticon palette for a messaging tool is dynamically generated, for example for a messaging tool executed on a mobile device, based on contextual, statistical, installed application and/or location analysis. The emoticon palette optionally includes emoticons with personalized commercial content. The palette may be generated according to textual and/or image analysis methods which detect keywords using one or more criterions. Each emoticon may be associated with one or more intention indications. The found keywords are used for matching commercial content to be embedded in emoticons and/or for matching existing emoticons with commercial content. As used herein, the term intention indication refers to one or more words that semantically represent one or more intentions of the writer and/or of a cited writer. The intention may indicate an action, a meaning, an idea, a wish, and/or a combination thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

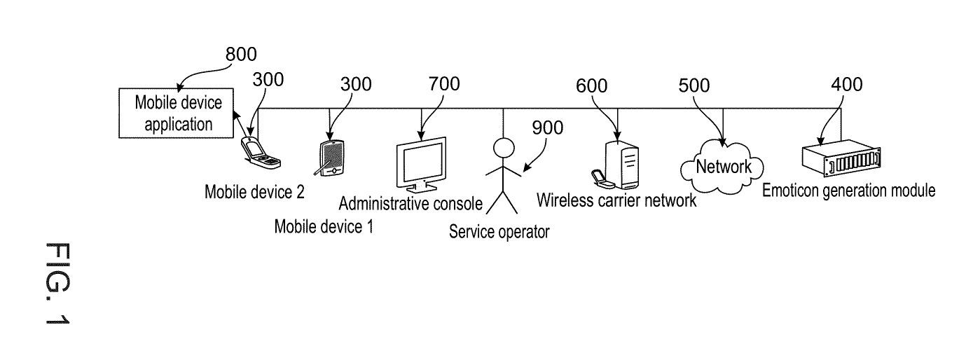

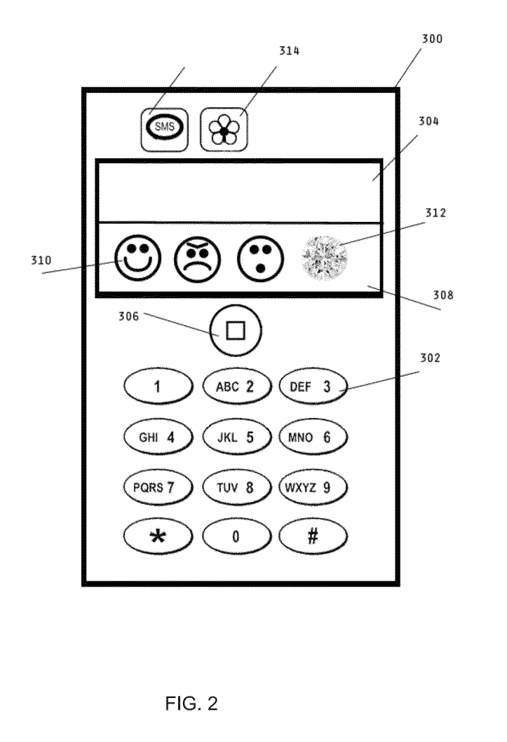

Reference is now made to FIGS. 1-2. FIG. 1 is a functional block diagram showing exemplary generalized system architecture that implements an emoticon palette generation system, according to some embodiments of the present invention. The system generates dynamically a customized emoticon palette for a messaging tool, for example on a messaging tool of a mobile device. The system generates the palette by an analysis of full textual messages, instant messaging messages and/or partial textual messages, for instance while the user or recipient is typing a message, and/or images, and/or photos, and/or keywords in a search queries submitted by the user or the recipient, and/or based on applications installed on the device. As used herein, the term keywords in a search query refers to any search item or question that the user is attempting to collect information on by searching an information repository such as the World Wide Web (WWW), and/or some database or a combination thereof. Each emoticon may be associated with one or more intention indications. The analysis may facilitate identifying categories of promotional content based on commercial features found in the analysis. Furthermore, the system may embed promotional content associated with one or more merchants into one or more custom emoticons allowing a user to select one or more emoticons to be inserted in a message and transmitted to one or more parties and/or posted in a social network page and/or blog. Additionally, the system may employee one or more variants of a revenue generating model in which advertisers and a service operator owning the system may engage in commercial activity having a prospect to benefit both parties. As used herein, the term engage refers to engaging any activity for economic gain involving the promotion of an advertiser's goods, and/or services and/or commodities by a service operator through the use of emoticons in a manner that may generate revenue for the advertiser.

As used herein, the term service operator refers to a commercial entity or business providing an emoticon generation service.

In accordance with embodiments of the invention, an emoticon generation system service operator can charge advertisers and merchants who embed, for example visually integrate, their promotional content onto emoticon(s) according to various billing methods, for example if the user types the commercial emoticon in a message or in an instant messaging message and/or uses a link embedded in the commercial emoticon as a coupon and/or to visit a webpage. Optionally, the link and/or any other promotional content is integrated with the emoticon such that when a recipient of the textual message receives the textual message, a selection of the emoticons, for instance by a click or a touch, induces the presentation of a popup containing the promotional content. The promotional content may include informative data selected by semantic analysis of the textual content of the text message, for instance information about a movie, a player, a sport game, a car model and/or the like.

A mobile device 300 is installed with a mobile device application 800. As used herein, the term application refers to executable software and optionally a graphical user interface (GUI) that implements certain functionality. The application may communicate with an emoticon generation module 400. The emoticon generation module 400 provides access to an emoticon database access module comprising a plurality of emoticons and may broadcast messages to a plurality of recipients and, in some embodiments, may be using the infrastructure provided by a wireless carrier network 600 and/or a network 500. As used herein, the term network refers generally to any type of telecommunications or data network including, without limitation, hybrid fiber coax (HFC) networks, satellite networks, telecommunications networks, and data networks including local area networks (LANs), metropolitan area networks (MANs), local area networks (LANs) and/or wide area networks (WANs), the Internet, and intranets.

The mobile device applications 800 may be installed on the mobile device before the mobile device is purchased and/or after the mobile device was acquired. Optionally, the mobile device applications 800 may be offered to the user either free of charge, at a discounted or subsidized rate, or some combination thereof.

The mobile device 300 communicates with one or more emoticon generation modules 400. As used herein, the term server refers to any computerized component, network node or entity adapted to provide communications protocols, data, files, applications, content, and/or other services to one or more mobile devices, other devices or entities on a network or a remote network node. The emoticon generation module 400 transmits its data to the network 500 that forwards the data to one or more of the wireless carrier network 600. Each applicable wireless carrier network 600 then transmits the data including a selected group of emoticons to one or more of its corresponding mobile devices 300. An emoticon palette generation module adds the selected group to an emoticon palette of the user interface. Then the user selects one or more emoticons or a group of emoticons from the emoticon palette. The emoticon generation module 400 then sends a message with the inserted selected group of member emoticons out to the targeted mobile devices(s) 300.

As used herein, the term device refers to any electronic device and/or mobile device, and/or wireless device, portable terminal, including, but not limited to personal digital assistants (PDAs), tablets, electronic book readers, handheld computers, cellular phones, personal media devices (PMDs), smart-phones, and the like. As used herein the term message may refer to data comprising text, speech, images, graphical messages or some combination thereof. As used herein, the terms graphics, graphical, photo and image may include or alternatively refer to; graphics photos, videos, images extracted from videos, information related to the photos and/or the videos and/or a combination thereof.

The system may include an administrative console and/or a user interface 700 that allows a system administrator to manage resources such as a merchant/advertiser catalog, promotional content management etc. available on the emoticon generation system. The mobile devices 300 communicate with one or more emoticon generation modules 400 by wirelessly transmitting data packets to a corresponding wireless carrier network 600 and a network 500.

In some embodiments of the present invention, the data packets may comprise one or more emoticons 310, one or more custom emoticons 312, text messages 322, vocal and graphical content or a combination thereof.

Optionally, data packets and groups of data packets may be designed, configured and encoded in a way that allows a broadcaster to represent an infinite number of emoticons using a finite number of bits in each data packet and transmit the packets to a plurality of recipients.

Optionally, the data packets may further be optimized for instance by binary compression and transmitted in a way that accelerates the transmission of, for instance, a large number of custom emoticons.

It should be noted that despite the fact that the consumer may use a mobile device 300 on a wireless carrier network, the network 500 may differ extensively. Thus it may equally utilize wired, landline and wireless communications or any combination thereof whilst not departing from the scope of the present invention.

The aforementioned data packets are then sent from the mobile device 300 broadcaster to a network module 500 that transmits them to the emoticon generation module 400 before being transmitted to a plurality of recipients 300. The packet-based network 500, emoticon generation module 400 and the wireless carrier network 600 may reside, for instance, inside a cloud computing system, and consist of public network elements, a private network element such as a corporate intranet, or an amalgamation of public and private network and/or cloud computing elements. As used herein, the term cloud computing refers to the utilization of a set of shared computing resources (e.g., servers, nodes, modules etc.) which are characteristically combined in one or more physical data centers.

Optionally, the emoticon generation system comprises of a plurality of servers that could be configured to implement the functionality portrayed below and in some embodiments providing redundancy and high availability. Those having ordinary skill in the art will recognize that the packet-based network 500, the emoticon generation module 400 and the wireless carrier network 600 may be placed inside a single element of, for instance, the wireless carrier's network 600, eliminated the need for multiple servers.

According to some embodiments, a service operator 900 owning and implementing the system of FIG. 1, engages commercially with merchants and advertises while allowing them to offer promotional content. The promotional content is then presented to the user using the emoticon generation service.

Optionally, as outlined above, the emoticon palette 308 includes one or more commercialized emoticons. The commercialized emoticons embed promotional content, for example from a merchant catalog module 450, optionally in a personalized and/or location based manner. This allows embedding promotional content of one or more advertisers in one or more emoticons and the promotional content is then presented to the user using the emoticon generation service.

As used herein, the term promotional content refers to any category of content which conveys information relating to a promotional, commercial, marketing, or monetary prospect of which one or more users may financially benefit from. Consequently, promotional content may contain, for instance, commercial recommendations, offers, coupons, discounts, subsidized products, marketing materials, etc. Embedding of promotional content such as, for instance a coupon, into an emoticon may be facilitated by allowing the user to click on an emoticon and subsequently leading the user to the merchant's web site permitting the user coupon redemption.

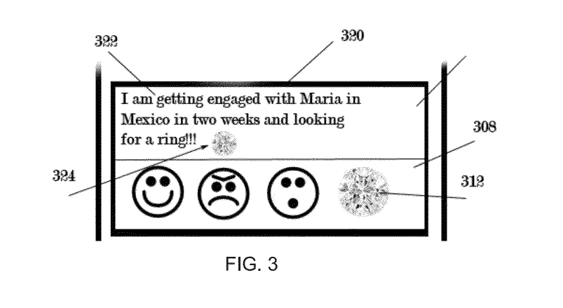

Reference is now made to FIGS. 2-3; FIG. 2 is an exemplary schematic illustration of a mobile device and exemplary embodiments aimed at the use of cellular telephones and tablets in accordance with some embodiments of the present invention. It should be noted, that the invention should not be understood to be limited to such devices only. As shown, the mobile device 300 comprises a keypad 302, a display 304, and a navigation key 306 that allows a user to navigate a general list or a list of emoticons.

One or more custom emoticons 312 may be selected by the user for insertion into a textual message in which case a selected custom emoticon(s) from the list are inserted in an appropriate location in the text message 324; Optionally, a dialog box for the insertion of graphics 314 that may be used by the user to embed an image/video into his message. A textual message 320 comprises; the exemplary text message 322 entered by the user and an exemplary diamond like custom emoticon 312 selected by the user from the palette to be inserted into the text 322 at the specified location 324. These and other possible components of the mobile device such as for instance, a microphone, which are not depicted here are well known in the art and need not be defined any further herein.

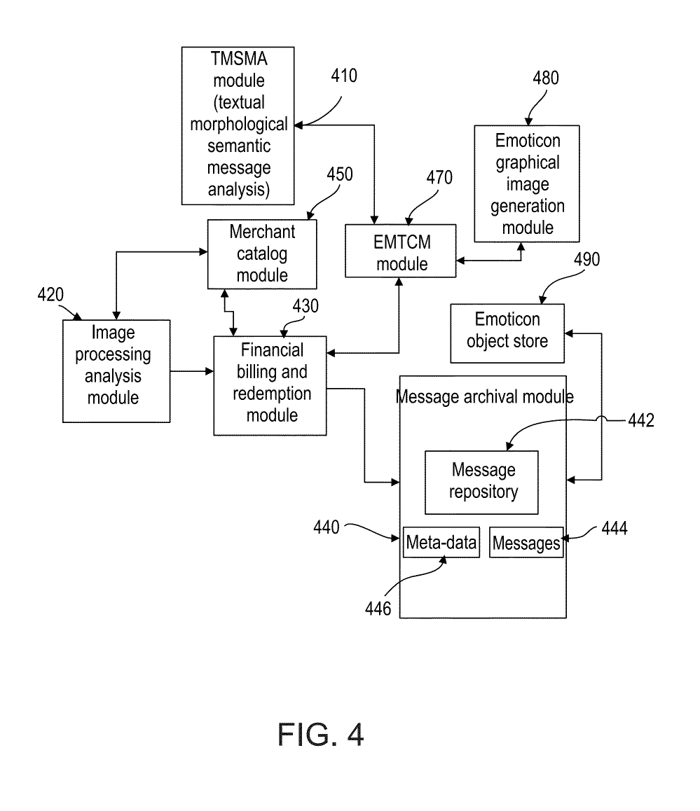

Reference is now made to FIGS. 1-4; FIG. 4 illustrates an emoticon generation module 400 comprising some or all of the following modules/l a textual morphological semantic message analysis (TMSMA) module 410; an image processing analysis module 420; a financial billing and redemption module 430; a message archival module 440; a merchant catalog module 450; a user registration module 460; an emoticon to message to commercial entity matcher module (EMTCM) module 470; an emoticon graphical image generation module (GIGM) 480; and an emoticon object store 490.

The TMSMA module 410 may employ natural language processing (NLP) algorithms to analyze text derived, for instance, from conversations between users or/and based one or more keywords submitted by the user to a search engine. The TMSMA module 410 derives morphology, classification, syntax, and/or semantics of textual content for messaging. For example, the textual content may be derived from any of a variety of sources, e.g., an outbound or inbound message(s), such as SMS message(s) and/or some other textual meta-data associated with the message(s); speech recognized text, keyboard entry, and/or the like. The module utilizes an automated morphological analysis to segment and classify the text sentence into a sequence of morphemes. Hence following an analysis, a plurality of commercially important features may be extracted from the text input. As exemplified below, the module may be used for commercial usages, e.g. the analysis results in commercially valid morphological categories. As used herein, the term morphological refers to rules of grammar that define the syntactic roles, or parts of speech, that a word may have such as noun, verb, adjective etc. As used herein, the term a morpheme refers to the smallest meaningful unit in the grammar of a language. For instance morphological analysis of the English word “Unwittingly” may yield four components, called morphemes. These are the root “wit” and three affixes, the prefix “un” indicating negation, and two suffixes “ing” and “ly”.

It is to be understood that the segmentation/morphological/classification algorithms may be accomplished using well-known techniques. For instance, segmentation may be implemented using machine learning algorithms, probabilistic techniques such as the Hidden Markov Model (HMM) and the like.

It is to be understood that emoticon insertion may take place anytime during one or more stages and/or using one or more methods. The stages may be for instance on the mobile device, and/or on the emoticon generation module 400 or a combination thereof. For instance, it may commence when the user is typing on the sender or recipient's device by the device user, and/or it may be done automatically at the sender's or recipient's device by an application running on the device, and/or just before sending it together with a textual message containing the emoticon to the emoticon generation module 400, and/or may be made automatically by the emoticon generation module 400.

We now present by way of example, and not limitation, an exemplary textual message analysis according to some embodiments of the present invention. It should be noted however, that the invention should not be understood to be limited to such textual analysis only.

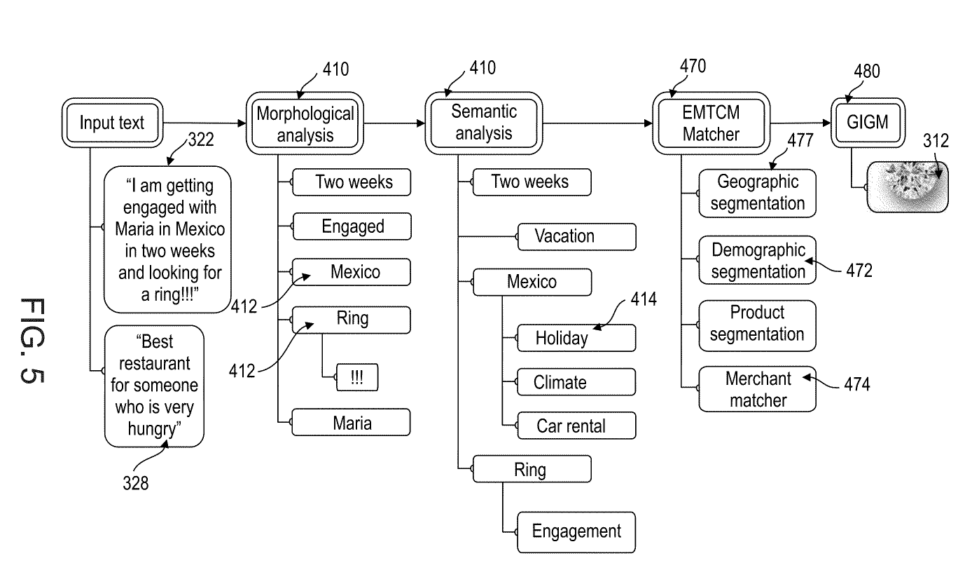

According to some embodiments of the present invention, and referring now also to FIG. 5, as shown, is an exemplary flowchart illustrating the full process of textual analysis and emoticon generation in which; the text message 322 or a search query 328 is analyzed by the TMSMA module 410, resulting in a list of morphemes such as “ring” and “Mexico”; the list is subsequently semantically analyzed resulting in a list of more morphemes obtained from querying a lexical dictionary (not depicted). It should be noted that the text message 322 may also be an instant messaging message. The lists 412 and 414 are used by the EMTCM module 470 which conducts demographic segmentation 472, geographic, and product segmentation. Successively, the EMTCM module 470 utilizes a merchant matcher 474 which is able to correlate between the analysis and the names of potential merchants and products. The output of the later process, which is a list of products and their respective merchants, is then used by the GIGM module 480 which generates a plurality of emoticons with promotional content. The emoticons are then persisted into an emoticon object store 490.

The EMTCM module 470 further employs the analysis performed by the TMSMA module 410 to exercise methods that can discover and correlate matching merchants, products, promotional content and offers that may be offered to a user by embedding promotional content into an emoticon. Such matching may be based, for instance, on semantic, morphological, demographic, behavioral attributes and the like or a combination thereof. For instance in some embodiments, it may target consumers in the immediate geographic vicinity of a plurality of merchants using the geographic segmentation module 477.

According to some embodiments of the present invention, an image processing analysis module 420 employs image processing methods and is used to analyze images, videos, photos, graphics and the like in order to extract a plurality of commercially important features and categories and map these features in order to generate relevant emoticons.

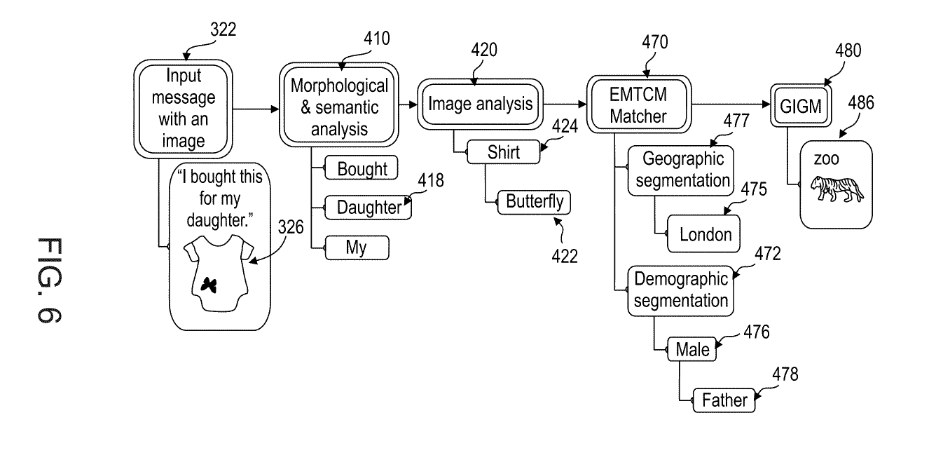

For example, reference is now made to FIG. 6 which depicts a flowchart of an image analysis process wherein exemplary text message 322 reading “I bought this for my daughter” and containing an image of a shirt with a butterfly printed 326 is inserted by the user and analyzed by the image processing analysis module 420; The image processing analysis module 420 analyzes the image using image processing methods and extracts commercially important features and/or meta-data related to the image such as for instance the fact that there is a shirt 422 and a butterfly 424 in the image. The text analysis module may also extract information such in the case that text exists in the text message 322 leading to commercially important morphemes such as 418.

Optionally, the textual and image analysis results are then used by the EMTCM module 470 which may process the extracted features and/or other information including meta-data such as for instance, the gender of the user broadcasting the message. The module EMTCM 470 may, for instance, based on the fact the gender of the user is male 476, determine that a father 478 bought a shirt for his daughter and that his daughter loves butterflies. The EMTCM module 470 may further utilize geographic segmentation 477 to determine that user may be located at London 475. Using the information that the module gathered so far, the module EMTCM 470 may generate, for instance an emoticon of a Zoo, pointing the user to a zoo in London 486 in which there may be a display of butterflies.

According to some embodiments of the present invention, the emoticon generation module 400 and/or the mobile device application 800 may interactively generate the emoticon palette based on the analysis of merely a single word, and/or incomplete sentences, for instance, while the sender and/or recipients are still typing a message. As used herein, the term incomplete sentence refers to one or more words and/or a morpheme and/or a sentence that is still being typed by the user. The emoticon generation module 400 may then automatically associate emoticons with the text analysis and subsequently present one or more emoticons to the user in the emoticons palette. The user may then select one or more emoticons for insertion into the text message. It is to be understood that the generation of a plurality of emoticons may take place simultaneously on the devices of one or more parties partaking in the conversation and may yield no emoticons, identical and/or different emoticons for each party or a combination thereof.

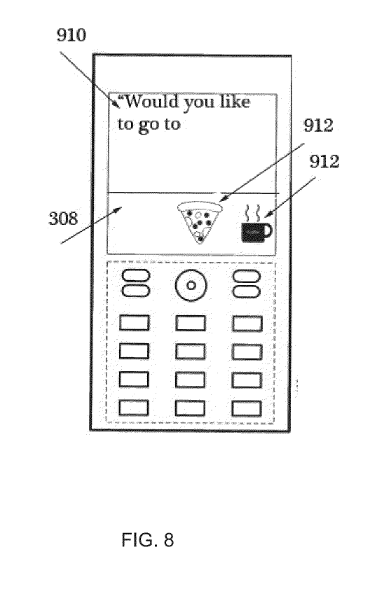

For example, reference is now made to FIG. 8 which is exemplary schematic illustration of a mobile device and exemplary emoticons created following analysis of incomplete sentence. The user starts typing a text message 910, reading “would you like to go”. While the user is still typing, the emoticon generation module 400 and/or the mobile device application 800 may interactively generate one or more emoticons 912 on the emoticon palette 308. The user may then select and insert one or more emoticons into the text message 910. The user may then send the message with the selected emoticons to a plurality of parties.

According to some embodiments of the present invention, the emoticon generation module 400 may automatically associate one or more emoticons with promotional content that is generated on the emoticon generation module 400. Under this aspect of the invention, the user first selects one or more emoticons from the emoticon palate and inserts the emoticon(s) into the text message and/or into a SMS and the like. The emoticons may be generated automatically following textual analysis or they may preexist on the palette as part of the application running on the device. The user then sends the adjusted textual message to a plurality of recipients. It is to be noted that the sender does not see the actual emoticons which are received by the recipients and has no notion of their visual appearance, and/or number and/or type. The message is sent by the user and analyzed by the emoticon generation module. The emoticon generation module 400 may then associate promotional content with one or more emotions irrespective of whether the emoticons are dynamically generated or preexisting. Once the message is received on the recipients' end, the recipients are presented with the textual message and/or SMS and are able to read the message and the emoticons are rendered on the user interface of their device terminal.

According to some embodiments of the present invention, the emoticon generation module 400 and/or the mobile device application 800 may interactively highlight one or more words and/or one or more morphemes and/or one or more incomplete sentences and/or one or more user inserted images in a message on a device terminal. The selection is based on textual and/or image analysis. The highlighting action may take place at the moment the user starts typing his message and/or during any of the stages for while the sender and/or recipients are still typing and/or when either part user finishes typing his message. As a result of highlighting, highlighted textual segment(s) on the device terminal becomes clickable. At his discretion, the user may click on the highlighted textual segment(s) and in the event opts to do so, the mobile device application will in response substitute the textual segment(s) with the user selected emoticon. The user then may send the message to a plurality of recipients and once the message is received on the recipients' end, the recipients are able to read the message and the emoticons are rendered on the user interface of the device terminal.

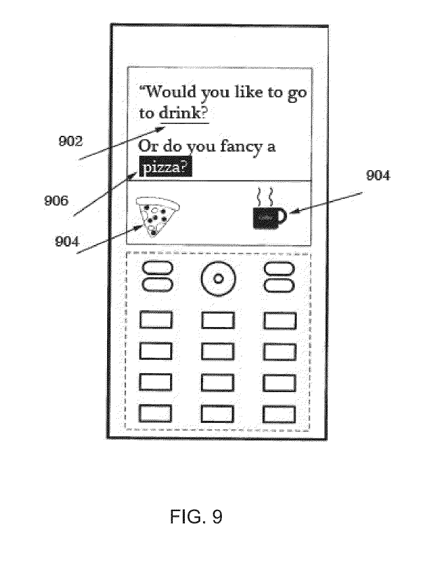

For example, reference is now made to FIG. 9 which is exemplary schematic illustration of a mobile device and exemplary text that is highlighted. The mobile device application 800 may automatically associate and suggest to the user, one or more emoticons 904 for one or more of the highlighted words and/or morphemes 902 and/or incomplete sentences and/or images. It is to be understood that the one or more words or morphemes 902 may be highlighted simultaneously and that one or more emoticons 904 may be suggested for the same or different word or morpheme. The user then may opt to click the highlighted text 902, view the associated emoticons 904 and may substitute the text he typed and/or the image that the application highlighted with the suggested one or more emoticons. It is to be understood that the action of highlighting on the user interface of the device terminal may be accomplished using several approaches, for instance, underlying the text 902, and/or rendering it in a different color, and/or surrounding it with a shape such as a rectangle 906, and the like.

According to some embodiments of the present invention, a message archival module 440 is provided comprising; a central repository 442 for storing the user's messages 444 and information or meta-data 446 related to the messages; meta-data 446 which may convey commercially important information and is associated with the messages being transmitted. This information may include, for instance, where and/or when a message was sent and/or to whom, or in the case of a photo who is in the photo and/or when and/or where it was taken and/or by whom (e.g., a house, a restaurant etc.). The information may be used by the system in conjunction with the text analysis to improve and/or to enhance the matching process between merchants and users. For instance, the meta-data 446 may be correlated with one or more of the previous user messages 444. The correlation process may involve for instance looking for the same or similar morphemes and or calculating word frequency and the like. This may lead to a finer granulated promotional content based not only on the context of the current message but rather from an analysis involving the full message history of the user.

Furthermore the meta-data 446 may include the geo-localized current location of the broadcaster and recipient and/or other location indications and/or demographic meta-data such as age, and/or gender, and/or marital status etc. Additionally, it may include older user messages having similar characteristics, and/or the name of the photo, and the title of the message, and/or the designated album name album, and the like or a combination thereof. The meta-data 446 may also be utilized by the EMTCM module 470 during its matching process.

According to some embodiments of the present invention, a merchant catalog module 450 is used to store his product list. Such a catalog may contain additional information and meta-data related to the actual products in the catalog such as associated keywords, seasons at which the product is most typically used, pricing, demographic and statistical data with respect to prior consumer behavior, and the like.

In one embodiment, the GIGM module 480 is purely graphical in the context that it has the logic and image processing and transformation methods appropriate for the dynamic generation of images representing emoticons in various forms. The GIGM 480 can generate emoticons by adapting various classes of image files to be custom emoticons. In one implementation, image files of various types and sizes are each standardized into an array pixel of identical dimensions to be used as emoticons. For instance in some embodiments, a jewelry merchant is offering to sell diamonds, and the module may generate an emoticon relevant to the merchant based on image provided. In some embodiments, the service operator may configure the billing module 402 to track financial transactions associated with an advertiser, a consumer and the targeted promotional content embedded into an emoticon. For instance, if the promotional content may be a link leading to a subsidized product on advertiser's web site, as depicted in the custom emoticon 312. Redemption of that subsidized product by the consumer may be automatically reported to the billing module by the advertiser who owns the redeemed coupon. Hence the service operator may also benefit financially from this transaction since it was the system offered by it that allowed the advertiser to be the beneficiary of the transaction with the consumer.

According to some embodiments, the service operator 900 implementing the system of FIG. 1 may engage commercially with one or more advertises allowing the merchants to offer promotional content. The emoticon generation system may be operable to store a plurality of advertisers and merchants in an object store provided by the merchant catalog module 450. The advertisers may pay for the emoticon generation service.

The financial oriented engagement, in which either one or both parties, e.g. the service operator and the advertisers, may be the beneficiaries, may be based on several revenue generating models.

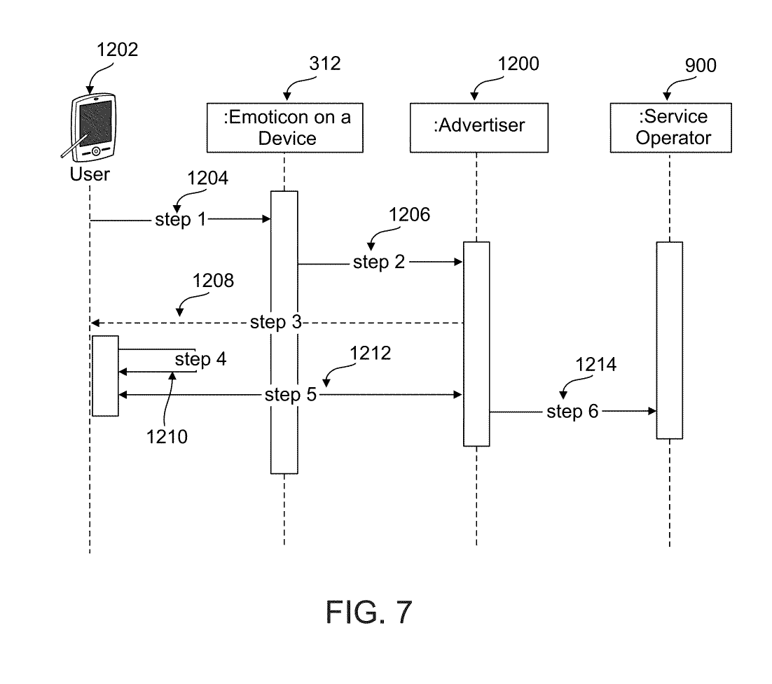

For example, reference is now made to FIG. 7 which depicts a sequence diagram of one variant of a revenue generating model.

Under this variant, the model may be as follows. First at 1204, the user 1202 clicks on the custom emoticons 312 which at 1206 directs the user 1202 to an advertiser's 1200 website and the user then may buy a product from the advertiser's catalog. Now at 1208, the advertiser 1200 provides the pricing information for the product the user selected. Next, the user 1202 may either: (a) choose not to buy anything in which case leading to 1210 and the sequence diagram terminates, or: (b) the user may choose to buy the product leading him to 1212 in which he pays for the product he selected. Subsequently, at 1212, the advertiser who benefited from this financial transaction completed by the user 1202 (e.g. buying one or more products from the advertiser's online catalog), pays a portion of his earning from this transaction to the service operator 900 at 1214. Thus, under this variant, a measure of engagement is the actual number of conversion events leading to a successful transaction associated with the emoticon used by the user. E.g. the service operator per user click charges merchants only if the user's visit actually resulted in advertiser's revenue.

In another example, when the user 1202 clicks on the custom emoticons 312, a pop up that includes reference data and/or data acquired from a third party is presented. In such an embodiment, a measure of engagement may be an actual number of conversion events leading to a successful transaction associated with the data in the pop up and/or any other revenue sharing model wherein the operator of the system is rewarded for the reference of its users based on the data in the pop up. For example, the service operator per user click charges merchants only if the user's visit actually resulted in advertiser's revenue.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant emoticon generation systems will be developed and the scope of the term emoticon generation is intended to include all such new technologies a priori. As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of dynamically generating an emoticon palette, comprising:
providing content presented to a user in a textual message editor of a terminal;
providing an access to a dataset comprising a plurality of emoticons each associated at least one of a plurality of intention indications;
identifying, according to a content analysis, at least one intention indication in said content;
selecting a group of emoticons from said plurality of emoticons according to a match between said at least one intention indication and said plurality of intention indications;
adding said selected group to an emoticon palette of said textual message editor; and
entering by said user which uses said textual message editor, at least one member of said selected group into a textual message in response to a selection from said emoticon palette; and transmitting said textual message.

2. The method of claim 1, wherein said plurality of emoticons comprises a promotional content.

3. The method of claim 1, wherein said content is received from said user as an input into said textual message.

4. The method of claim 1, wherein said content is extracted from another textual message presented to said user using said user interface, said textual message is a response to said another textual message.

5. The method of claim 1, wherein said content is an instant messaging content and said textual message is an instant messaging message.

6. The method of claim 1, wherein said content is a short message service (SMS) content and said textual message is an SMS message.

7. The method of claim 1, wherein said content comprises a textual content and said content analysis is textual analysis.

8. The method of claim 1, wherein said content comprises an incomplete sentence having at least one morpheme, said content analysis is a textual analysis.

9. The method of claim 1, wherein said content comprises at least one image and said content analysis is an image analysis.

10. The method of claim 1, wherein said providing an access to a dataset comprises establishing a communication with a remote network node which manages said dataset.

11. The method of claim 1, wherein said identifying comprises identifying a current location of said terminal, said selecting is performed according to current location.

12. The method of claim 1, further comprising identifying a plurality of applications installed in said terminal; and wherein said selecting is performed according to said plurality of applications.

13. The method of claim 1, further comprising identifying at least one keyword in a search query submitted to a search engine using in said terminal; and wherein said selecting is performed according to said at least one keyword.

14. A communication terminal, comprising:
a display;
a user interface module which presents a user interface on said display for entering by a user textual content for a textual message;
an emoticons database access module which provides an access to a dataset comprising a plurality of emoticons each associated at least one of a plurality of intention indications;
a selection module which identifies, according to a textual analysis, at least one intention indication of said user in said textual content and selects a group of emoticons from said plurality of emoticons according to a match between said at least one intention indication and said plurality of intention indications;
an emoticon palette generation module which adds said selected group to an emoticon palette of said user interface;
wherein said user interface allows said user to enter at least one member of said selected group into said textual message; and
wherein said communication terminal transmits said textual message with said at least one member and said textual content.

15-16. (canceled)

17. A method of dynamically associating promotional content, comprising:
receiving a textual message created by a user in a textual message editor of a terminal to an operator, said textual message is designated to at least one recipient;
detecting at least one emoticon in said textual message;
associating at least one content object for said at least one emoticon in said textual message; and
forwarding an adjusted textual message that includes said textual message and said at least one emoticon with an association to said promotional content to said at least one recipient;
wherein said promotional content is presented to a recipient of said adjusted textual message by at least one of an integration into said at least one emoticon and a rendering of a pop up containing said promotional content in response to a user selection of said at least one emoticon by said recipient.

18. The method of claim 17, wherein said integration comprises adding a link directing said recipient to said promotional content in response to a user selection of said at least one emoticon.

19. The method of claim 17, wherein said textual message is an instant messaging message.

20. The method of claim 17, further comprising presenting said textual message and said at least one emoticon with said promotional content to said at least one recipient and to said user in a chat user interface.
